(19) United States
(12) Patent Application Publication
(10) Pub. No.: US 2009/0037255 A1
(43) Pub. Date: Feb. 5, 2009

(54) Behavior aggregation

(76) Inventors: Leo Chiu, South San Francisco, CA (US); Peter Loukianoff, Oakland, CA (US)

Correspondence Address: Stevens Law Group, 1754 Technology Drive, Suite #226, San Jose, CA, 95110, US

(21) Appl. No.: 12/152,464

(22) Filed: May 14, 2008

Related U.S. Application Data
(63) Continuation-in-part of application No. 11/635,375, filed on Dec. 6, 2006.
(60) Provisional application No. 60/930,546, filed on May 16, 2007.

(51) Int. Cl. G06Q 30/00

(52) U.S. Cl. 705/10; 705/14

(57) ABSTRACT

After receiving a call from a caller, the identity of the caller is determined. A method determines at least one caller behavior associated with the caller. This caller behavior is determined based on the caller's association with a social network. Next, multiple available advertisements are identified. An advertisement is selected based on the caller behavior associated with the caller.

### RELATED APPLICATIONS

This application is a Continuation in Part of U.S. patent application Ser. No. 11/635,375, filed Dec. 6, 2006, the disclosure of which is incorporated by reference herein. This application also claims the benefit of U.S. Provisional Application No. 60/930,546, filed May 16, 2007, the disclosure of which is incorporated by reference herein.

### TECHNICAL FIELD

The present invention relates to collecting information about various users from multiple sources, such as data associated with online communities.

### BACKGROUND

Various types of advertisements can be communicated to users via any number of different communication media and communication mechanisms. A specific type of advertisement, referred to as a “targeted advertisement”, is communicated to a specific user based on information known about that user. For example, if a user is an avid bicycle racer, targeted advertisements would include advertisements related to upcoming bicycle races, bicycle racing apparel, and bicycle racing magazines. The more information an advertiser has about a particular user, the more effectively advertisements can be targeted to that particular user. For example, if the advertiser knows that the user participates in bicycle races of a certain length and typically races in the Western United States, the advertiser can further narrow the type of advertisement provided to the user to include races of the appropriate length and in the appropriate geographic area.

Targeted advertisements are beneficial to the advertiser because they generally receive a better response rate than non-targeted advertisements. For example, sending bicycle racing advertisements to someone who has no interest in bicycles is not likely to generate a positive response. Further, such advertisements may be annoying to users that have no interest in the content of the advertisement. Targeted advertisements are less likely to be an annoyance to users because there is a strong likelihood that the user has an interest in the content of the advertisement. Thus, increased knowledge about the user can benefit the advertiser with improved response rate and benefit the user by reducing the number of non-interesting advertisements received.

### BRIEF DESCRIPTION OF THE DRAWINGS

Similar reference numbers are used throughout the figures to reference like components and/or features.

FIG. 1 illustrates an example environment in which the systems and methods discussed herein can be applied.

FIG. 2 is a flow diagram illustrating an embodiment of a procedure for aggregating user information.

FIG. 3 illustrates another example environment in which the systems and methods discussed herein can be applied.

FIG. 4 is a block diagram illustrating various components of an example advertisement management system.

FIG. 5 is a flow diagram illustrating an embodiment of a procedure for creating and editing advertisements.

FIGS. 6-9 represent a flow diagram that illustrates an embodiment of a procedure for playing one or more advertisements to a caller.

FIG. 10 is a block diagram illustrating an example computing device.

### DETAILED DESCRIPTION

The systems and methods described herein provide a mechanism for aggregating user information, such as user behavior information, user buying habits, user age, user occupation, user martial status, and the like. The aggregated user information is useful in targeting advertisements to users, identifying common behaviors among groups of users, and so forth.

Using the systems and methods described herein, an advertiser (or another person or entity responsible for communicating advertisements to users) can retrieve user information from multiple sources, such as social networking sites, caller-identification information, stored data related to previous user transactions and/or user activities, etc. Although particular examples discussed herein refer to obtaining user information from one or more social networking sites, similar information can be obtained from any type of online community that links together multiple users.

The systems and methods described herein further allow advertisers to create and manage multiple advertisements, such as voice-based advertisements, targeted by various parameters. These parameters include, for example, user behavior, geographic area, business category, time-of-day, day-of-week, advertising budget, throttle settings, coupons, and the like. An example advertisement references an audio file and/or a text-to-speech transcript for generating an audio advertisement played to one or more callers. A caller is any person that uses any type of communication system and method to exchange audio data with another person, system, or entity. The systems and methods described herein allow advertisers to create advertisements that can target consumers at the instant they are making a buying decision (e.g., when a consumer calls a directory assistance service requesting a particular business or product/service).

In particular embodiments, a “user” is also referred to as a “caller”. The systems and methods described herein receive calls (or requests for calls) from various callers. For example callers may place calls to request directory assistance (also referred to as “411 service”), call a business, call a friend, and so forth. The caller may invoke a call via a conventional telephone system, using voice over internet protocol (VoIP), using a mobile phone over a wireless network, or any other communication system. Directory assistance typically provides a phone number for a particular individual or business. Directory assistance systems may also connect the caller to the desired individual number. Alternatively, directory assistance may provide any type of information to a caller, such as address information, business location, business hours, etc.

Certain examples discussed herein refer to receiving directory assistance requests from callers via a telephone or a cellular phone. However, the systems and methods discussed herein may also be utilized to process requests received from any source using any type of data communication mechanism and any kind of data response mechanism. Although certain examples provided herein refer to calls for directory assistance, similar procedures and systems can be used to provide in-call advertisements for any type of call, including VoIP calls, calls to businesses, calls to individuals, and the like. For example, a caller initiating a VoIP call may hear an advertisement “This call is being sponsored by Acme Computer Systems” before the call is connected to the destination. Revenue from this type of advertisement helps reduce or eliminate the cost of providing the VoIP call service.

Specific examples discussed herein relate to voice advertising (e.g., playing voice or other audio-based messages to callers). However, the systems and methods discussed herein can be used with any type of advertising and with any type of advertisement management system. Alternate types of messages include text messages, email messages, instant messages, graphics and the like. The described systems and methods may be implemented as a stand-alone system or may be incorporated into one or more other systems.

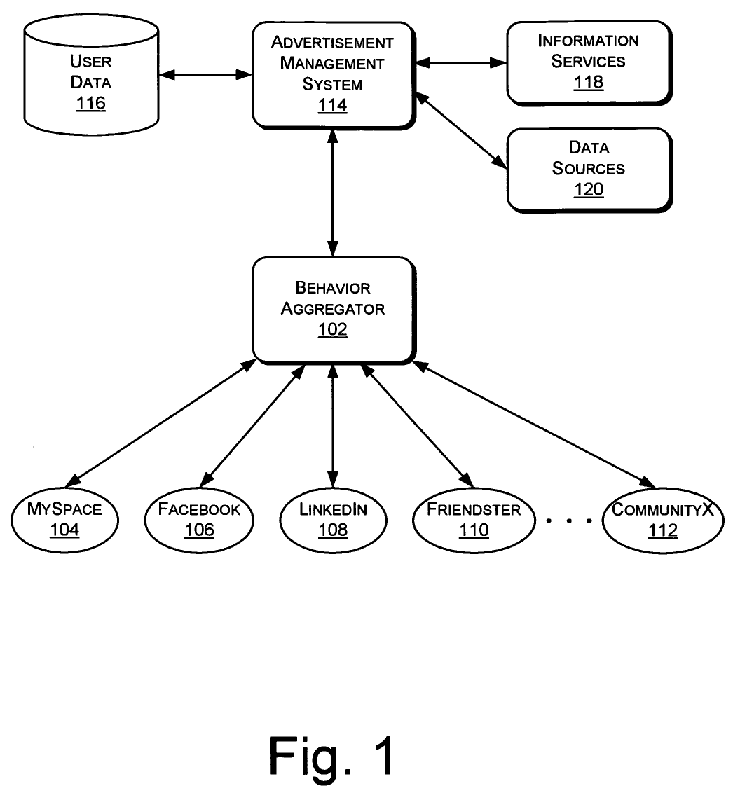

FIG. 1 illustrates an example environment in which the systems and methods discussed herein can be applied. A behavior aggregator 102 is coupled to multiple social networking sites via a data communication network link, such as the Internet. The multiple social networking sites (e.g., Web sites) include MySpace 104, Facebook 106, LinkedIn 108, Friendster 110 and any number of other communities identified as CommunityX 112. Behavior aggregator 102 is capable of receiving user information from all of the social networking sites 104-112. This received user information may be used alone or in combination with other information known about the user to target one or more advertisements or other information to the user. Although FIG. 1 shows behavior aggregator 102 coupled to specific social networking sites, alternate embodiments may include additional social networking sites not shown in FIG. 1, or may eliminate one or more of the social networking sites shown in FIG. 1. As mentioned above, a “social networking site” can be any type of online or network-based community that links together multiple users. The multiple users may be linked together for any reason, such as common friends, common relatives, common interests, common school, common location of residence, common hobbies, common careers, and the like. Behavior aggregator 102 is also capable of aggregating behavior information from other sources, such as credit card purchase histories, web browsing histories, email history, inbound and outbound telephone call history, and the like.

Behavior aggregator 102 is also coupled to an advertisement management system 114. Advertisement management system 114 communicates advertisements to users based on information known about the users and based on the types of advertisements available to be communicated to the users. Advertisement management system 114 is coupled to a user data store 116 (e.g., a database of user information), one or more information sources 118, and one or more data sources 120. User data store 116 contains, for example, user information obtained from previous transactions with the user, ANI (Automatic Number Identification) information, DNIS (Dialed Number Identification Service) information, and the like. Information services 118 include any number of different services that provide information about a user based on the user's name, phone number, or other identifying information. Additionally, information services 118 may include one or more “411 services” or other directory service information providers. Data sources 120 provide data in response to data requests that include user identification information such as phone number, email address, or name. When advertisement management system 114 receives a request for a targeted advertisement for a particular user, advertisement management system 114 collects user information from one or more of: behavior aggregator 102, user data store 116, information sources 118, and data sources 120. The collected information is used to select the best available advertisement for the particular user (i.e., the advertisement that is most likely to be of interest to the particular user).

In a particular implementation, each user is asked if they are willing to provide access to one or more social networks with which they are affiliated. If the user chooses not to provide information regarding their social networks, then advertisement management system 114 continues to select a target advertisement for the user based on information received from other sources. If the user provides access to one or more social networks (e.g., by providing a social network login name and password), then advertisement management system 114 selects a target advertisement for the user based on information received from the one or more social networks as well as other sources. The information received from the one or more social networks may be stored (e.g., in user data store 116) for use in selecting future advertisements or other information for the user. Example information received from the one or more social networks includes user hobbies, user activities/interests, user music preferences, user television preferences, user book preferences, user career, user travel preferences, etc.

Particular examples discussed herein refer to the selection of one or more advertisements to be communicated to the user. In alternate embodiments, the systems and methods discussed herein provide other types of information to the user based on the data received about the user. The other types of information may include store hours, driving directions, maps, coupons, and the like.

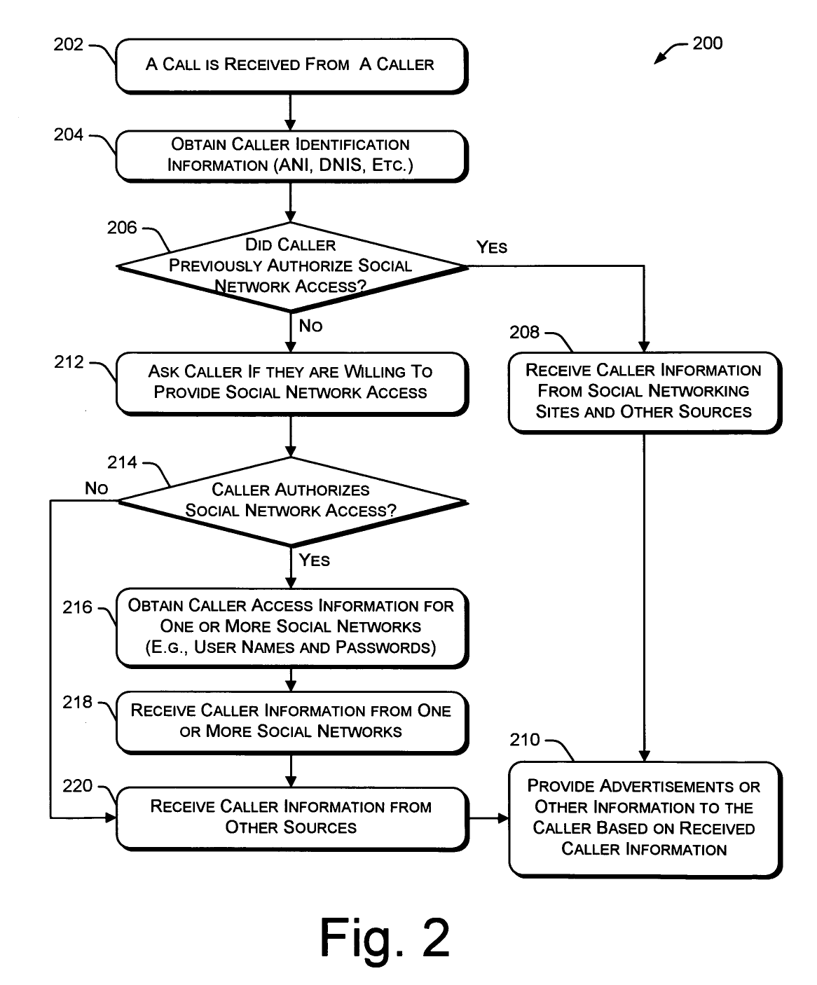

FIG. 2 is a flow diagram illustrating an embodiment of a procedure 200 for aggregating user information, including behavior information, from multiple sources and providing targeted advertisements or other information to the user based on the aggregated user information. In one embodiment, procedure 200 is implemented in the environment shown in FIG. 1. In other embodiments, procedure 200 is implemented using one or more computing devices or other systems capable of performing the operations shown in FIG. 2. In the particular embodiment of FIG. 2, procedure 200 refers to a “caller”, which is one example of a “user”. Other examples of “users” include, “mobile callers”, “cell phone users”, “portable computer users”, “mobile device users”, and the like.

Procedure 200 begins when a call is received from a caller (block 202). The procedure obtains caller identification information about the caller (block 204). This identification information includes information retrieved using ANI, DNIS, and similar services. The procedure then determines whether the caller previously authorized social network access (block 206). This authorization may be obtained through an “opt-in” procedure where the caller accesses an “opt-in” Web site or responds to an “opt-in” email message. If the caller previously authorized social network access, the procedure receives caller information from one or more social networking sites and other sources (block 208). The procedure continues by providing advertisements or other information to the caller based on various information received about the caller (block 210).

If the caller has not previously authorized social network access, the procedure continues from block 206 to block 212, where the caller is asked if they are willing to provide social network access. If the caller authorizes social network access, the procedure obtains caller access information for one or more social networks (block 216). The caller access information includes, for example, a user name and password used by the caller to access their social network account. Procedure 200 then receives caller information from the social networks to which the caller authorized access (block 218). Caller information may be obtained by harvesting data from social network Web sites or other data sources. This harvesting of data can be performed via the application program interfaces (APIs) provided by the social network Web site, such as Facebook Connect, My Space Data Availability, and Google Friend Connect.

After obtaining caller information from one or more social networks, procedure 200 continues by receiving caller information from other sources (block 220). The procedure then provides advertisements or other information to the caller based on the received caller information from the social networks and other sources (block 210).

If the caller does not authorize access to any social networks at block 214, the procedure branches to block 220, thereby skipping the steps associated with accessing social networks. In this situation, the procedure receives caller information from other sources (block 220) and provides advertisements or other information to the caller based on information received from the other sources (block 210).

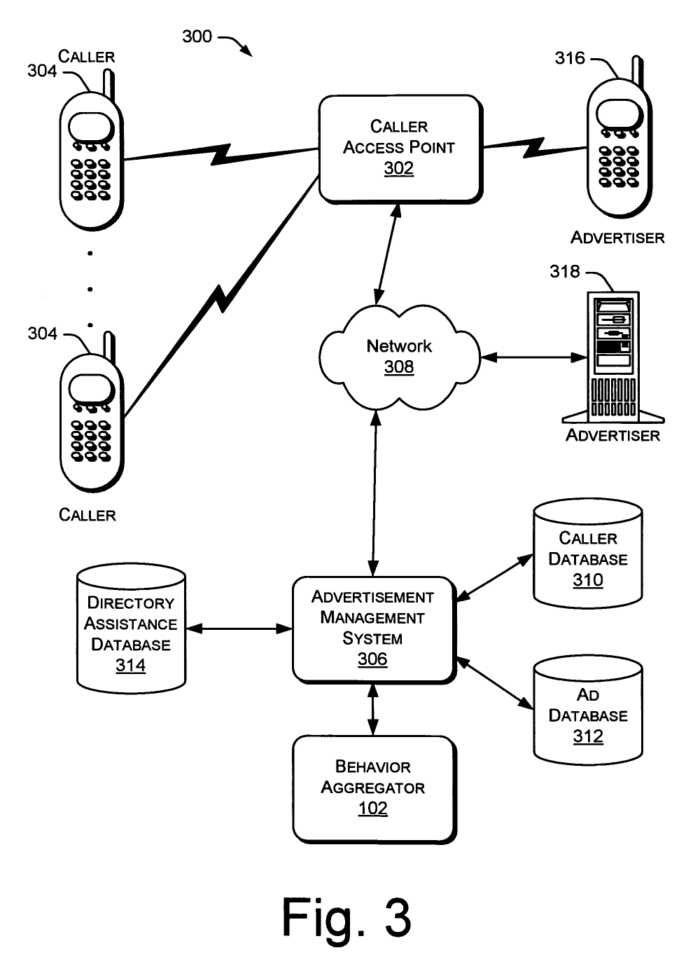

FIG. 3 illustrates another example environment 300 in which the systems and methods discussed herein can be applied. Environment 300 includes a caller access point 302, which receives calls from multiple callers 304. A typical caller access point 302 is capable of handling numerous calls from callers 304 simultaneously. Caller access point 302 may be a PBX phone system or other system capable of handling multiple calls simultaneously. In a particular embodiment, caller access point 302 is a directory assistance access point that receives requests from callers for directory assistance.

Caller access point 302 communicates with an advertisement management system 306 via a data communication network 308. Advertisement management system 306 performs various advertisement-related functions, such as creating and editing advertisements, selection and ranking of advertisements based on various factors, and playing advertisements to callers. Additional details regarding the operation of advertisement management system 306 are provided below.

Data communication network 308 can be implemented using any communication protocol and any type of communication medium. In one embodiment, data communication network 308 is the Internet. In other embodiments, data communication network 308 is a combination of two or more networks coupled to one another. Caller access point 302 and advertisement management system 306 communicate with network 308 via a wired and/or wireless communication link. In a particular embodiment, caller access point 302 and advertisement management system 306 communicate audio data using a VoIP connection. This embodiment may utilize a VoIP bridge or gateway between caller access point 302 and network 308, and between advertisement management system 306 and network 308.

Advertisement management system 306 is also coupled to a caller database 310, an advertisement database 312, a directory assistance database 314, and behavior aggregator 102, discussed above. Caller database 310 contains information related to various callers, such as types of businesses requested in previous calls, types of advertisements received during previous calls, geographic location of the caller, caller demographics, and the like. This caller information, combined with caller behavior information obtained from behavior aggregator 102, allows advertisement management system 306 to target appropriate ads to the caller. Advertisement database 312 contains various advertisements and information associated with those advertisements. Advertisement database 312 also contains advertisement campaign history data used for reporting, generating new advertising campaigns, and so forth. Directory assistance database 314 contains phone numbers, addresses, and other information associated with numerous businesses and individuals. Although three separate databases 310, 312, and 314 are shown in FIG. 3, alternate embodiments may include any number of databases coupled to advertisement management system 306. Further, alternate embodiments may combine database information into more or less than three databases. For example, caller database 310 and advertisement database 312 may be merged into a single database. Similarly, the data contained in caller database 310 may be distributed across multiple databases (e.g., one database for caller data mined by advertisement management system 306, and a second database for caller data obtained from a third party data source).

Caller access point 302 is also accessible by an advertiser 316 using a telephone or similar communication device. For example, advertiser 316 may communicate with advertisement management system 306 via caller access point 302 to create or edit an advertisement. Alternatively, an advertiser 318 may communicate with advertisement management system 306 via a network connection through network 308. For example, advertiser 318 may communicate with advertisement management system 306 to create or edit an advertisement, review historical campaign data, or generate a report of advertising activity.

In a particular embodiment, caller access point 302 includes an invoking application, which interacts with callers and invokes advertising management system 306. The invoking application can be a directory assistance application, a VoIP application, an interactive voice response (IVR) application—such as for a supermarket, department store or movie theater, and the like. In one implementation, the invoking application receives a call and requests one or more advertisements from advertising management system 306. Advertising management system 306 then identifies advertisements based on information associated with the received call and provides those advertisements to the invoking application for playback to the caller. The invoking application then reports information about the advertisements back to advertising management system 306. The reported information includes, for example, which ads were played to the caller, which ad was selected by the caller, and whether the caller accepted any offers, such as competitor coupons or competitor discounts. This reported information is used by advertising management system 306 to provide advertising statistics and results to the advertisers placing the various advertisements. In one embodiment, an application program interface (API), discussed below, is provided by advertising management system 306 that allows one or more invoking applications to interact with the advertising management system.

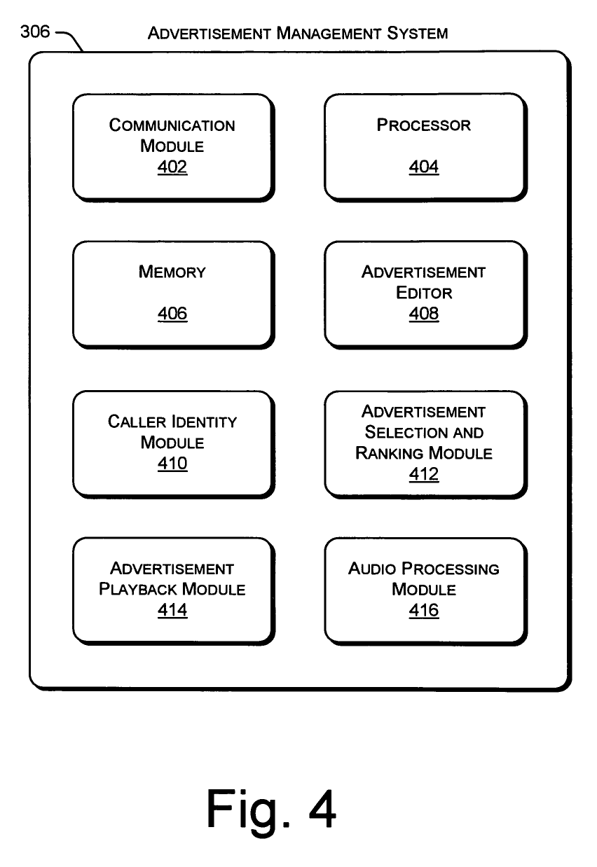

FIG. 4 is a block diagram illustrating various components of example advertisement management system 306. Advertisement management system 306 includes a communication module 402, a processor 404, and a memory 406. Communication module 402 allows advertisement management system 306 to communicate with other devices, such as databases, networks, other computer systems, and so on. Processor 404 executes various instructions to implement the functionality provided by advertisement management system 306. Memory 406 stores these instructions as well as other data used by processor 404 and other modules contained in advertisement management system 306.

Advertisement management system 306 also includes an advertisement editor 408, which allows users (e.g., advertisers, certified marketing representatives (CMR's), and ad agencies) to create and edit advertisements. Advertisement editor 408 also allows users to define various parameters associated with each advertisement, such as the business category, geographic location to target the advertisement, time of day to run the advertisement, maximum bid price, and the like. Users can access advertisement editor 408 via a telephone or via a network connection (e.g., through the Internet). Additional information regarding creating and editing advertisements is discussed below.

Advertisement management system 306 further includes a caller identity module 410, which determines the identity of a caller. For example, caller identity module 410 may receive a phone number associated with an incoming call. Caller identity module 410 accesses a caller database or other data source to determine the identity of the caller. Once the caller is identified, additional information about the caller can be retrieved from caller database 310 or another internal or external data source. This additional information includes, for example, information requested from previous directory assistance calls, previous advertisements played to the caller, demographics of the caller, environmental factors, and the like. Example environmental factors include the current temperature in a geographic area and whether snow is forecast for the area. Such additional information is useful in targeting advertisements of interest to the caller.

Advertisement management system 306 also includes an advertisement selection and ranking module 412. This module selects one or more advertisements to be played to a caller based on various factors, which are discussed in greater detail herein. Advertisement selection and ranking module 412 also ranks multiple advertisements based on one or more criteria. This ranking determines the order in which the multiple advertisements are presented (e.g., played) to the caller. An advertisement playback module 414 plays advertisements in the form of audio files, text-to-speech data, or other data to one or more callers. Advertisement playback module 414 performs the necessary data processing to convert the advertisement data into audible sounds that are communicated to the caller.

An audio processing module 416 performs various filtering and other modifications to audio recordings to improve the sound quality of the audio advertisement and to maintain consistent volume levels, consistent audio quality, and the like between multiple audio recordings. For example, audio processing module 416 may reduce background noise, reduce “clicks and pops” in the recording, modulate the frequencies in the recording, and generally smooth the audio sounds. These audio processing steps are particularly useful for audio advertisements created by an advertiser calling from a poor quality telephone connection.

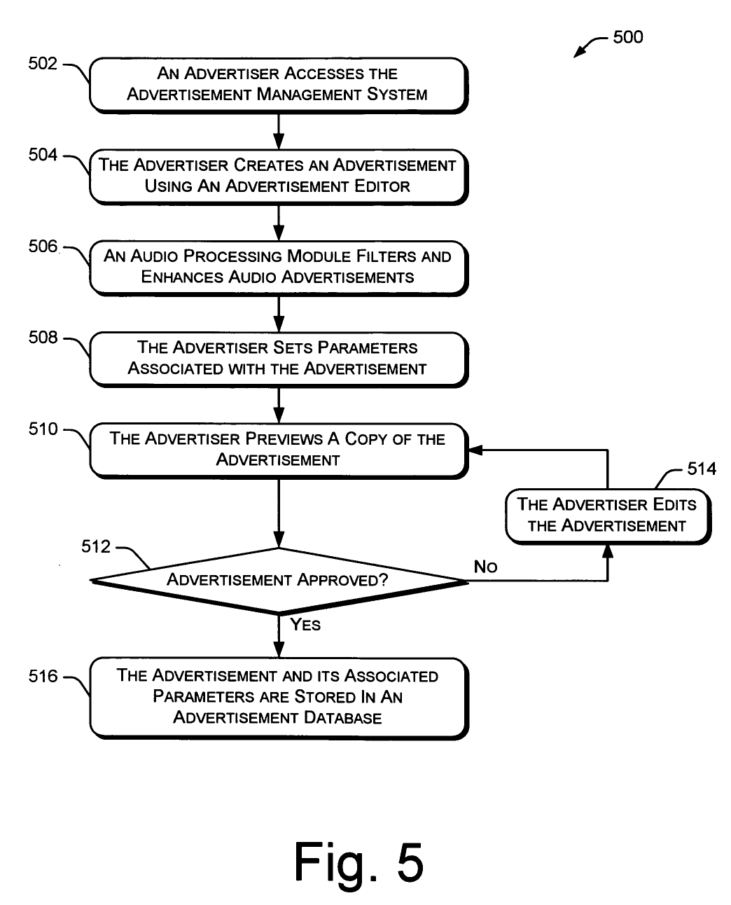

FIG. 5 is a flow diagram illustrating an embodiment of a procedure 500 for creating and editing advertisements. Initially, an advertiser accesses advertisement management system 306 discussed above (block 502). The advertiser can access the advertisement management system by telephone or via the data communication network shown in FIG. 3. The advertiser continues by creating (or editing) an advertisement using an advertisement editor (block 504), such as advertisement editor 408 shown in FIG. 4.

After creating or editing an advertisement, an audio processing module filters and enhances the audio portion of the advertisement (block 506). For example, the audio processing of block 506 can perform the audio processing discussed above with respect to audio processing module 416 in FIG. 4. Procedure 500 continues as the advertiser sets parameters associated with the advertisement (block 508). Example parameters include type of advertisement, business category, maximum bid price, and times that the advertisement can be played. Table 1 below identifies various parameters that can be associated with a particular advertisement.

After setting parameters associated with an advertisement, the advertiser previews a copy of the advertisement (block 510). This preview of the advertisement includes listening to the audio portion of the advertisement, viewing any visible portions of the advertisement, and reviewing the parameter settings associated with the advertisement. The parameter settings may be provided to the advertiser audibly or visually. If the advertiser approves the advertisement at block 512, procedure 500 continues to block 516 where the advertisement and its associated parameters are stored in an advertisement database, such as database 512 shown in FIG. 5. If the advertiser does not approve the advertisement at block 512, the advertiser is given an opportunity to edit the advertisement (block 514) and preview the revised copy of the advertisement.

The following Table identifies multiple parameters that can be associated with advertisements. Certain advertisements may use a portion of the parameters shown in Table 1.

TABLE 1

| Parameter | Description | Example |
|---|---|---|
| Ad Type | Front-End Sponsor Ad, | Sponsor Ad for Pizza |
| | Back-End Sponsor Ad, | Delivery |
| | Competitive/Switch-Away | |
| | Ad, My Listing Ad, | |
| | Category Ad, Movie Ad, | |
| | Supermarket Ad, etc. | |
| Ad Category | Business category | Automobiles |
| Ad Sub-Category | Business sub-category | Porsche Automobiles |
| Monthly Budget | Monthly limit across all | $5000/month |
| | advertisements | |
| Daily Budget | Daily limit across all | $200/day |
| | advertisements | |
| Ad Budget | Monthly limit per ad | $50 per ad/month |
| Day of Week | Days advertisement will be | Friday through |
| | played | Sunday |
| Time of Day | Times advertisement will | 9:00 am-3:00 pm |
| | be played | |
| Locality | Geographic area in which | San Francisco Metro |
| | advertisement will be | Area |
| | played | |
| Max Bid | Maximum amount the | $1.50/placement |
| | advertiser is willing to pay | |
| | for a single ad placement | |
| | or connection | |
| Throttle | Defines the maximum | Maximum of 10 calls |
| | frequency of ad placement | per hour |
| Routing | Defines the exit handling | Route to Order |
| | for an ad placement | Capture System |
| Audio Content | The audio file or transcript | Acme.wav |
| | containing the voice | |
| | content of the | |
| | advertisement | |
| Wireless Content | The image file or text | AcmeCoupon.jpg |
| | containing the wireless | (coupon image) |
| | content of the | |
| | advertisement | |

A particular advertisement may include some or all of the parameters identified in Table 1. For example, an advertisement that does not include an image or text will not have an associated Wireless Content parameter. The Locality parameter may be nationwide or define a state, city, metropolitan area, area code, or area code and prefix.

An advertisement for a pizza restaurant might have the hours for ad placement match the hours they are open, for example 11 am to 10 pm, with no throttle defined during most of the day. However, since they have lots of business between the hours of 5 to 7 pm, they would create a separate placement for that timeframe and could set the throttle to 12. This would mean that they would get no more than 12 calls per hour during those 2 hours, and these calls would be distributed over the 60 minutes, preferably occurring approximately once every five minutes. This would give the restaurant time to handle all their other customers.

There are many of types of ads that can be managed with this in-call advertisement system. In particular embodiments, five different types of advertisements could be used: front-end sponsor advertisements, back-end sponsor advertisements, competitive advertisements (also referred to as “switch-away advertisements”), my-listing advertisements, and category advertisements. Front-end sponsor ads are typically played to a caller as soon as the caller is connected to the service. A particular type of front-end sponsor ad, a targeted spot ad, selects among several ads to play based on information known about the caller. For example, if a particular caller has previously called directory assistance and requested pizza businesses, the advertisement management system will likely play a pizza-related sponsor ad for that caller. Additionally, the advertisement management system may charge more for a pizza-related advertisement played to this particular caller because the caller has previously requested pizza businesses before. For example, the advertiser is charged 35 cents for an advertisement played to a caller who previously requested a pizza business, and the advertiser is charged 25 cents for the same advertisement played to a caller who had not previously requested a pizza business.

A back-end sponsor ad is typically played when no “middle ad” has been played, such as a switch-away, my listing, or competitive ad. A “my listing” ad is an ad for the sponsor's business. A back-end sponsor ad is typically played if it matches and complements the front-end ad. In the example above, if a pizza-related ad was played to the caller and no middle ad was played, a back-end sponsor pizza ad from the same merchant could be played to the caller before the call transfer is made, to remind him one last time of their service, offer a coupon, or announce the daily special.

A competitive/switch-away advertisement is provided to a caller in response to the caller's request for a competitor's business. For example, if a caller requests the phone number for “Bob's Pizza”, a competitive ad would provide information (e.g., via an audio ad) to the caller regarding a different company (such as “Pizza Depot”), which is a competitor of “Bob's Pizza”. Competitive advertisements may be triggered in response to requests for one or more specific businesses or in response to a request for any business in a particular category. For example, an advertiser (Bob's Pizza) can create a competitive advertisement for callers requesting “Mike's Pizza”. In this example, the advertisement is only played when people request “Mike's Pizza”. Alternatively, the advertiser (still Bob's Pizza) can create a competitive advertisement for callers requesting any pizza business by name or any keyword. In this situation, the advertisement is played when a caller requests “Mike's Pizza”, “Roundhouse Pizza”, or any other pizza business meeting the locale and other parameters set by the advertiser.

A “my listing” ad is an advertisement that is triggered by a request from the caller for the advertiser's listing. In one example, a “my listing” advertisement is used to block a competitor from playing a competitive/switch-away advertisement. In another example, the advertiser has to out-bid the competitive/switch-away ads from the competitors.

A category advertisement is associated with a particular business category. When a caller asks to search by category, typically two or three ads would play matching the caller's category and the caller would be given an opportunity to be connected to one of the advertisers. Pricing for category advertisements can be set by auction (as described herein) or by paying a specific price to obtain a particular rank among the multiple ads. Alternatively, the cost of a category advertisement may have a cost associated with playing the ad to the caller, an additional cost for ranking the ad in one of the top positions for earlier playback to the caller, and an additional cost if that ad is selected by the caller.

Pricing on advertisements is typically set in an auction, based on maximum bid information provided by the advertiser when creating or placing the advertisement. Pricing may vary depending on the type of ad, time-of-day, day-of-week, and so forth. When an advertiser is creating or editing an ad, the advertisement management system reports the current high bids for the same category of advertisement in the same locale. Reporting current high bids lets the advertiser choosing a maximum bid for their advertisement. For example, if the top three bids are “30 cents”, “35 cents” and “50 cents”, and the advertiser bids less than 30 cents, their ad will not likely be one of the top three ads provided to callers. Based on the advertiser's bid, the advertisement management system determines the placement of that ad among other competing ads.

In a particular embodiment, if a particular ad is pushed out of the “top three” ads for a particular category and locale, the advertiser associated with the “pushed out” ad is notified via an outbound call, email, text message, or other notification system. The advertiser associated with the “pushed out” ad is given the current top three bids for the particular category and locale. The advertiser is then given an opportunity to increase the bid for their ad to put their ad back in the “top three” ads for the particular category and locale. For example, the advertiser can simply press a particular button on their phone or click a button in an email message to automatically increase their maximum bid to keep their advertisement in the top three positions (or press/click a different button to automatically increase their maximum bid to keep their advertisement in the top position. In other embodiments, an advertiser is notified if their ad is pushed out of the top position, the top two positions, or any other number of top positions.

When setting maximum bid values for advertisements, the advertiser can also specify a daily maximum value for each advertisement, for a group of advertisements, or for all of the advertisements associated with a particular advertiser. Similarly, the advertiser can specify a weekly or monthly maximum value for each advertisement, for a group of advertisements, or for all advertisements associated with a particular advertiser.

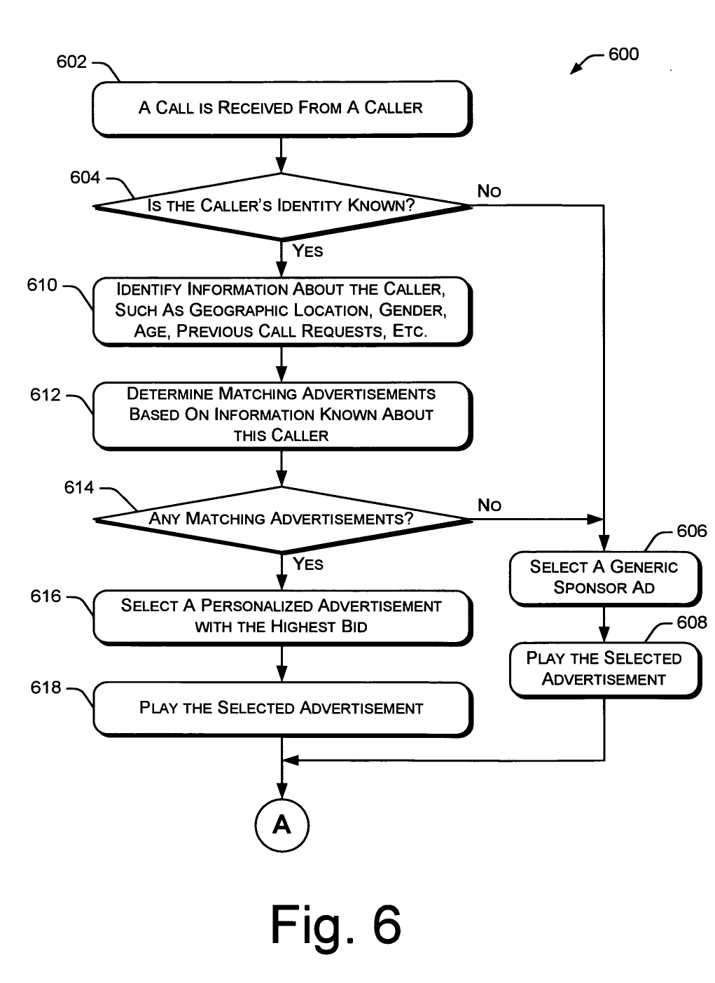

FIGS. 6-9 represent a flow diagram that illustrates an embodiment of a procedure 600 for playing one or more advertisements to a caller. Initially a call is received from a caller (block 602). Procedure 600 then determines whether the caller's identity is known, for example, by accessing a caller database and identifying the caller's identity based on the incoming call phone number (block 604). If the caller's identity is not known (e.g., no incoming call phone number or no record in the caller database), the procedure branches to block 606 where a generic sponsor advertisement is selected. Non-targeted sponsor ads are played based on bid value. If all bid values are the same, the ad that was played the longest time ago would be played next. Alternatively, if all bid values are the same, an advertisement may be selected at random. The selected advertisement is then played for the caller (block 608). This type of advertisement is an example of a front-end sponsor advertisement.

If the caller's identity is known at block 604, the procedure continues to block 610 where procedure 600 determines information about the caller, such as the geographic location of the caller, the caller's gender, the caller's age, one or more business categories associated with previous directory assistance requests, or other known data about the caller obtained from various sources, such as behavior aggregator 102. The procedure then determines whether the advertisement management system contains any available advertisements that match the interests or preferences of the caller (block 612). If not, the procedure branches to block 606 to select a generic sponsor advertisement and then to block 408 to play the selected advertisement.

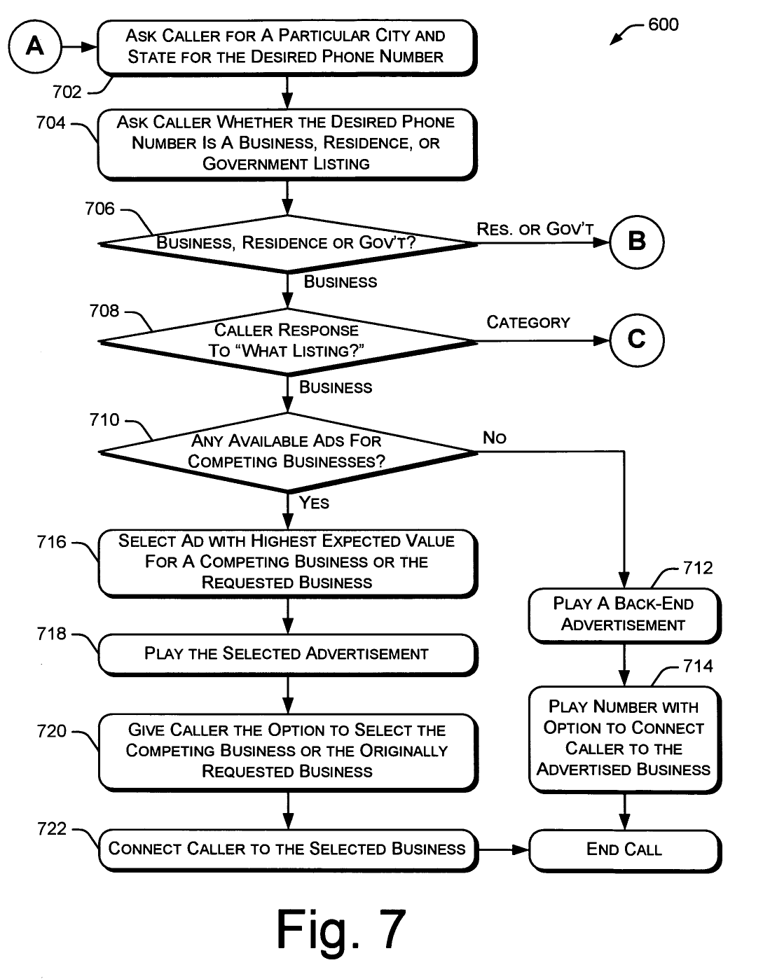

If procedure 600 determines that the advertisement management system contains one or more available advertisements that match the interests or preferences of the caller, the procedure selects a personalized advertisement with the highest bid (block 616). Next, the procedure plays the selected advertisement (block 618) and continues with the call at point “A” in FIG. 7.

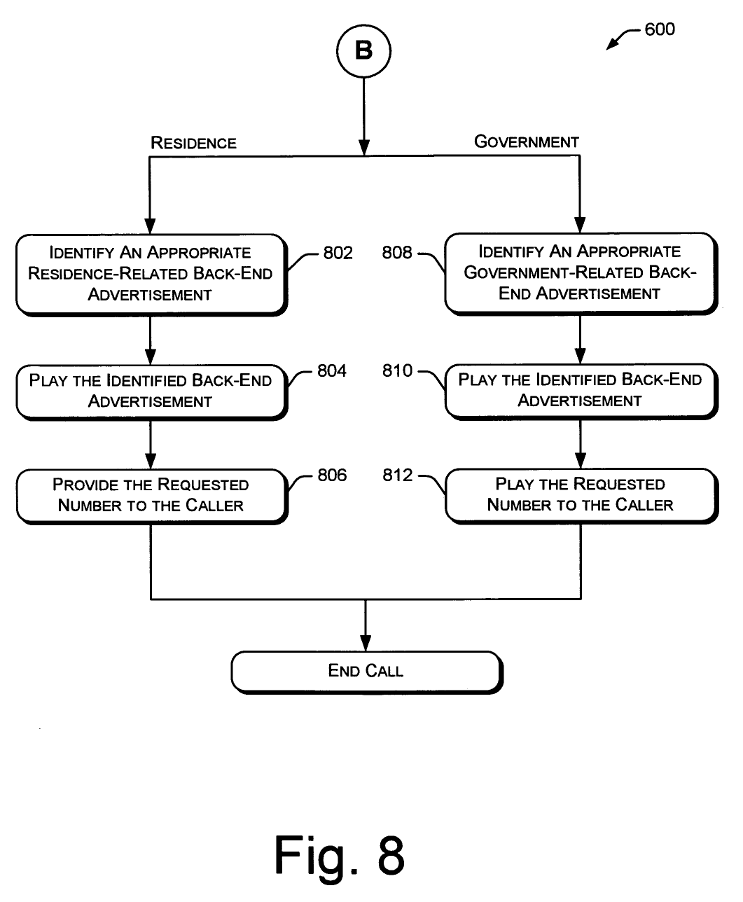

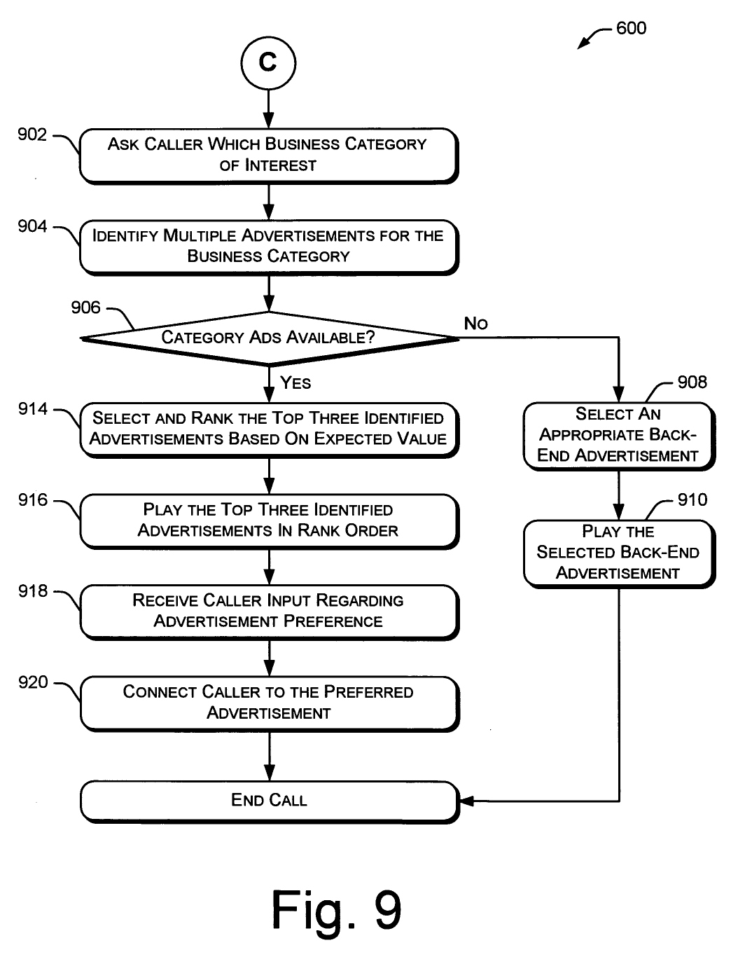

In FIG. 7, procedure 600 continues as the automated or live operator asks the caller for the city and state of their search (block 702). Next, the operator will ask if it is a search for a business, government, or residential listing (block 704). If the search is for a government or residence listing, the call branches to point “B” in FIG. 8. If the search is a request for a business, the procedure continues to block 708, where the operator asks the caller “what listing?” If the caller's response is for a particular category of business, the procedure branches to point “C” in FIG. 9. Otherwise, the caller's response is treated as a request for a business listing, and the procedure determines whether the advertisement management system contains a “my listing” ad for that particular business or any available advertisements for competing businesses (block 710). If not, the procedure branches to block 712 to select and play an appropriate back-end sponsor advertisement and then to block 714 to play the number with the option to connect the caller to the advertised business.

If procedure 600 determines that the advertisement management system contains one or more viable advertisements for the business, the procedure selects the advertisement with the highest expected value (block 716). An ad is deemed viable if it matches all the business rules of the advertiser, such as time-of-day, day-of-week, location, budget, throttle, etc. When selecting an advertisement with the highest expected value (i.e., an advertisement that is expected to generate the highest revenue for the entity providing the advertising service), the process may consider bids for various types of ads. For example, the procedure may consider bids for “my listing” type advertisements as compared to “switch away” type advertisements for competing businesses. If a particular “my listing” advertisement has a bid of $1.00 and a related “switch away” advertisement has a bid of $1.50, the procedure will select the “switch away” advertisement instead of the “my listing” advertisement.

Procedure 600 then plays the selected advertisement (block 718) and gives the caller the option to select the competing business or the originally requested business (block 720). The caller is then connected to the selected business (block 722). Finally, the procedure ends the current call.

All viable competitive ads and category ads are selected based on their bid values and expected value. In one example, a caller to a business listing can be redirected 40% of the time to a competitor if a coupon is offered by the advertiser, but only 20% of the time if no coupon is offered. In a particular situation, the caller is asking for “Bob's Pizza” and there are two viable ads for that time of day and day of week. One ad, with no coupon has a bid of $4.00, while another ad with a coupon has a bid of $3.00. The system would play the $3.00 ad since its expected value is $1.20 ($3.00×40%) while the other ad had an expected value of $0.80 ($4.00×20%).

In the example above, coupons can be sent to a caller's phone, personal digital assistant (PDA), fax machine, email address, or other device/account for display or other rendering on the phone or other device. Such coupons are particularly useful with competitive advertisements. In addition to coupons, the caller may be sent maps, directions, product photos, and the like. These items may be in a text format, a visual format (such as JPEG), an HTML format, or any other format understood by the receiving device.

In FIG. 8, procedure 600 continues from point “B” by following the left path if the caller requested a residence and following the right path if the caller requested a government listing. If the caller requested a residence listing, the procedure identifies an appropriate back-end advertisement for the caller (block 802). For example, the procedure may select a back-end advertisement that is associated with a previously played front-end advertisement. The procedure then plays the identified back-end advertisement (block 804). Finally, procedure 600 provides the number associated with the requested listing to the caller (block 806). The procedure then ends the call.

If the caller requested a government listing, the procedure identifies an appropriate back-end advertisement for the caller (block 808). The procedure then plays the identified back-end advertisement (block 810). Next, procedure 600 provides the number associated with the requested listing to the caller (block 812). The procedure then ends the call.

In FIG. 9, procedure 600 continues from point “C” by asking the caller what business category they are seeking (block 902). The procedure continues by identifying multiple advertisements for businesses in the requested business category (block 904).

If there are no viable ads that match the requested business category, the system will read out the names of numbers of the listings to the caller, then the ad system will select an appropriate back-end sponsor advertisement (block 908). The system then plays the selected back-end sponsor ad (block 910).

If there are viable ads that match the category request of the caller, one embodiment of the advertisement management system selects and ranks the top three identified advertisements, based on their expected value (block 914). In alternate embodiments, the advertisement management system selects and ranks any number of top identified advertisements (such as the top two advertisements or the top five advertisements).

Procedure 600 continues by playing the top three identified advertisements in rank order (block 916). Next, the procedure receives caller input regarding their advertisement preference (block 918) and connects the caller to the source of the preferred advertisement (block 920). The procedure then ends the call.

In alternate embodiments, a caller may provide one or more keywords instead of the name of a company. For example, a caller may request “pipe repair” rather than “plumber” or “Bob's Plumbing”. In this situation, the systems and methods described herein search for businesses that most closely match the keyword provided by the caller. The systems and methods may then identify one or more advertisements to play for the caller following the procedures discussed herein.

The advertising management system discussed herein collects information regarding advertisement statistics for reporting to advertisers. For example, the advertising management system stores information regarding the number of times an advertisement is played to a caller, the number of times an advertisement is selected by a caller, the cost of each advertisement playback, the ranking position of each advertisement playback, and so forth. This information is reported to advertisers to allow the advertisers to evaluate the results of their advertising campaigns.

As mentioned above, in certain embodiments an application program interface (API) is provided by advertising management system 306 (FIG. 3, 4) that allows one or more invoking applications to interact with the advertising management system. Example API parameters include geographic locality, business category, number of advertisements desired, dialed number information service (DNIS) data, and automatic number information (ANI) data.

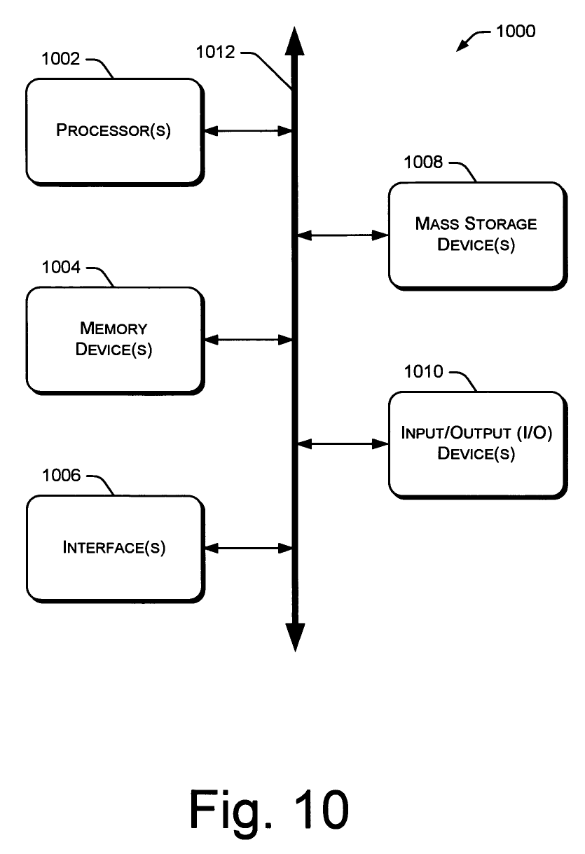

FIG. 10 is a block diagram illustrating an example computing device 1000. Computing device 1000 may be used to perform various procedures, such as those discussed herein. Computing device 1000 can function as a server, a client, or any other computing entity. Computing device 1000 can be any of a wide variety of computing devices, such as a desktop computer, a notebook computer, a server computer, a handheld computer, and the like.

Computing device 1000 includes one or more processor(s) 1002, one or more memory device(s) 1004, one or more interface(s) 1006, one or more mass storage device(s) 1008, and one or more Input/Output (I/O) device(s) 1010, all of which are coupled to a bus 1012. Processor(s) 1002 include one or more processors or controllers that execute instructions stored in memory device(s) 1004 and/or mass storage device(s) 1008. Processor(s) 1002 may also include various types of computer-readable media, such as cache memory.

Memory device(s) 1004 include various computer-readable media, such as volatile memory (e.g., random access memory (RAM)) and/or nonvolatile memory (e.g., read-only memory (ROM)). Memory device(s) 1004 may also include rewritable ROM, such as Flash memory.

Mass storage device(s) 1008 include various computer readable media, such as magnetic tapes, magnetic disks, optical disks, solid state memory (e.g., Flash memory), and so forth. Various drives may also be included in mass storage device(s) 1008 to enable reading from and/or writing to the various computer readable media. Mass storage device(s) 1008 include removable media and/or non-removable media.

I/O device(s) 1010 include various devices that allow data and/or other information to be input to or retrieved from computing device 1000. Example I/O device(s) 1010 include cursor control devices, keyboards, keypads, microphones, monitors or other display devices, speakers, printers, network interface cards, modems, lenses, CCDs or other image capture devices, and the like.

Interface(s) 1006 include various interfaces that allow computing device 1000 to interact with other systems, devices, or computing environments. Example interface(s) 1006 include any number of different network interfaces, such as interfaces to local area networks (LANs), wide area networks (WANs), wireless networks, and the Internet.

Bus 1012 allows processor(s) 1002, memory device(s) 1004, interface(s) 1006, mass storage device(s) 1008, and I/O device(s) 1010 to communicate with one another, as well as other devices or components coupled to bus 1012. Bus 1012 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 1000, and are executed by processor(s) 1002. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A method comprising:
receiving a call from a caller;
determining the identity of the caller;
determining at least one caller behavior associated with the caller, wherein the at least one caller behavior is determined based on the caller's association with a social network;
identifying a plurality of available advertisements; and
selecting one of the plurality of available advertisements based on the at least one caller behavior associated with the caller.

2. A method as recited in claim 1 further comprising determining additional information associated with the caller from another data source.

3. A method as recited in claim 1 further comprising offering the caller an opportunity to authorize access to at least one social network.

4. A method as recited in claim 1 further comprising:
determining whether the caller has authorized access to at least one of the caller's social network accounts; and
if the caller has authorized access to at least one of the caller's social network accounts, retrieving information regarding the caller from the authorized social network accounts.

5. A method as recited in claim 1 further comprising storing the identity of the caller with the associated caller behavior.

6. A method as recited in claim 1 wherein selecting one of the plurality of available advertisements based on the at least one caller behavior associated with the caller includes matching advertisement content with the caller behavior.

7. A method comprising:
receiving a directory assistance request from a caller;
attempting to determine the identity of the caller;
if the caller's identity cannot be determined, playing a sponsor advertisement prior to providing the directory assistance service to the caller; and
if the caller's identity is determined:
determining at least one caller behavior associated with the caller, wherein the at least one caller behavior is determined based on the caller's association with a social network;
identifying a plurality of advertisements of possible interest to the caller based on the caller behavior, wherein each of the plurality of advertisements has an associated bid price;
selecting an advertisement having a highest associated bid price; and
playing the selected advertisement to the caller.

8. A method as recited in claim 7 wherein the bid price associated with each advertisement is determined by a sponsor of the advertisement.

9. A method as recited in claim 8 wherein the bid price is set as a maximum price the sponsor will pay for each playback of the advertisement.

10. A method as recited in claim 8 wherein the bid price is set by the sponsor via a telephone-based interface.

11. A method as recited in claim 8 wherein the bid price is set by the sponsor via an Internet-based interface.

12. A method as recited in claim 7 further comprising providing the directory assistance service to the caller after playing the selected advertisement to the caller.
